(19) United States
(12) Patent Application Publication
(10) Pub. No.: US 2003/0202652 A1
(43) Pub. Date: Oct. 30, 2003

(54) Characterization of telephone circuits

(76) Inventors: Hector M. Vasquez, Livonia, MI (US); Timothy F. Gorka, Dillsburg, PA (US)

Correspondence Address: Michael de Angeli, MICHAEL M. DE ANGELI, P.C., 60 INTREPID LANE, JAMESTOWN, RI, 02835, US

(21) Appl. No.: 10/134,726

(22) Filed: Apr. 30, 2002

(51) Int. Cl. H04M 1/24; H04M 1/00

(52) U.S. Cl. 379/387.01; 379/27.01

(57) ABSTRACT

The apparatus is a device that measures the attenuation effects of a telephone circuit's physical construction, electrical characteristics, and equipment with respect to a series of waveforms at different frequencies, then combines the resultant values to create and display a reference number called the Vasquez Number (VN), a unitless number that, once generated, becomes a representative signature of the circuit under test. This number can then be employed to compare ostensibly identical circuits, to identify aberrations indicative of wiretaps or other unauthorized equipment, or to monitor the circuit over time to determined whether such additional devices have been added.

### FIELD OF THE INVENTION

This application relates to methods and apparatus for test and analysis of telephone circuits and networks, particularly in order to detect changes in circuit characteristics indicative of wiretaps, unauthorized use, and the like. More specifically, this invention relates to an instrument for characterizing telephone lines in an objective and repeatable fashion. The instrument can be used for monitoring the line by repeated testing in order to detect changes indicative of faults, wiretaps, or the presence of unauthorized equipment. Alternatively, nominally identical lines can be compared to one another to determine whether faults are present on any of them.

### BACKGROUND OF THE INVENTION

There are of course numerous reasons for testing telephone circuits. The specific tests involved can run the gamut from simply determining whether basic telephone functions are available to determining whether wiretapping connections have been established. The test equipment involved exhibits a similar range of sophistication.

Many attempts in particular have been made to provide effective detection of wiretapping equipment, defined for this purpose as an unauthorized connection to an active two-wire telephone circuit. As will appear below, other circuit problems and faults exhibit characteristics similar to wiretaps, and their detection is included in the detection of wiretaps as referred to herein.

Desirably, detection of wiretaps and the like is to be made possible by a “single-ended” test, that is, requiring connection of the test equipment to the telephone circuit only at the subscriber's premises; it will be appreciated that detection of the presence of wiretapping equipment is comparatively straightforward if the line can be isolated, e.g., by disconnection at the telephone company's central office, but this is often impracticable or impossible. Similarly, it is desirable to be able to detect wiretaps and other flaws on a “wet” circuit, that is, one that is in service; again, detection is much simpler if the circuit is disconnected or “dry”, but this complication is desirably to be avoided. Accordingly, reference herein to detection of wiretaps and the like according to the invention is to be understood to involve an instrument making a single-ended connection to an active circuit, thus not requiring access to the telephone company facility, unless otherwise stated.

Until the present invention, detection of even extremely simple wiretap equipment in the manner set forth above was considered to be impossible, as set forth in testimony of James Ross to the Congress in November 1986. The present invention addresses and satifies this need of the art.

Most known telephony test apparatus measures circuit, device or component values in common units of electrical measurement, e.g., volts, ohms, or dB. As set forth more fully below, the apparatus according to the invention calculates and displays a unitless but replicable value, referred to herein as the Vasquez Number (“VN”), that becomes a signature of the circuit under test.

More particularly, because truly identical circuits (having the same run length, same gauge wire, same switch, same conditioning equipment, etc.) will cause the apparatus to generate the identical VN signature values, the apparatus provides a heretofore unachievable task in telephony, that is, to allow objective comparison of two or more ostensibly-identical telephone circuits without having to perform an exhaustive physical inspection of every detail of the telephone lines along their entire runs. This allows determination that the two ostensibly-identical lines are not in fact identical, for example, if one or the other has been tapped or otherwise interefered with.

Accordingly, because the device of the invention can inferentially detect the presence of wiretaps by reporting a different VN number for two supposedly identical circuits, or by detecting different VN numbers for the same circuit measured at two different times, the device provides an effective detector for wiretap circuits or the presence of unauthorized devices, such as exta telephone circuits or the like.

A wiretap detection device shown in Hensley patent U.S. Pat. No. 4,634,813 continually monitors certain electrical characteristics of one or two telephone lines to detect changes in line properties that might be indicative of the addition of a wiretap device. The Hensley device measures and stores values for the impedance, resistance, voltage, and closed loop current in the circuit, and these are compared to typical values as one means of detecting a wiretap or other unauthorized device. Then Hensley transmits a triangular wave of unspecified frequency content, a square wave also of unspecified frequency content, and a sine wave of between 200 and 10,000 Hz onto the line. The sine wave is intended to trigger “tone-actuated intruder devices”, the square wave to activate “pulse activated intruder listening devices”, and the triangular wave as “the signal source for the pulse power refelctor test” (col. 4, lines 25-40). These signals are reflected back, and the reflected signals are detected, integrated, and “converted to digital form”; it is not clear precisely what is being thereby measured. However, Hensley does note that certain “intruder listening devices will vary the overall inductive reactance of the circuit and thus the attenuation of the reflected signal” (col. 4, lines 66-68), and so it may be that Hensley is seeking simply to measure the amplitude of the various reflected signals. The digitized values are then stored and used for successive comparison with similar signals, i.e., to detect changes indicative of activation of a listening device or the like.

Boeckmann patent U.S. Pat. No. 4,680,783 teaches measurement of the circuit impedance with reference to a baseline value determined at a time when the line is known to be free of taps to sense the presence of a wiretap. A wiretap of sufficiently high impedance, when introduced with the proper care, would be undetectable by the Boeckmann device. Boeckmann relies on a initial physical inspection of the circuit to assess that no wiretaps were present, and then relies on detection of the change in impedance to sense the introduction of the wiretap.

Published PCT application WO 99/52256, in the name of Vasquez, one of the present inventors, and U.S. patent application Ser. No. 09/668,569 in the name of Steven Newton claiming priority therefrom, both now abandoned, and from which the present application does not claim priority, teach a fault detector for connection to a telephone line for detecting abnormal conditions such as the presence of wiretaps or other circuit faults. The device as there disclosed applies a signal of at least about 20,000 hz to the telephone circuit under test, and measures the attenuation of the reflected signal. In typical use, a baseline measurement is made, and the test repeated periodically to determine whether circuit characteristics have changed, possibly indicating the connection of a tapping device or the like.

“Attenuation” in this connection refers to a loss of transmitted signal strength in the circuit between a transmitter and receiver, which occurs as a signal encounters impairments such as junctions, corroded connections, faults in the “copper”, i.e., wiring, presence of telephone instruments, wiretaps, etc., losing its strength (amplitude) along the way. The degree of attenuation experienced by a given pulse or signal varies with frequency. Attenuation would normally be determined by employing a sending unit that transmits a pulse of known signal strength and frequency into the circuit, and a receiving unit at the other end of the circuit that measures the strength of the received signal. However, it is operationally impractical to position sending and receiving units at all locations along a test circuit. In order for a detection device to be practical, therefore, a unit that can both send the test signal and measure the strength of the signal after attenuation is required.

An electrical phenomenon termed “reflectivity” causes a fraction of a signal pulse that is sent from a transmission source into a circuit to be reflected from circuit junctions at which the circuit impedance changes, so as to travel back toward the transmitting location. Accordingly, by operation of the test device in transmit and receive modes, the same instrument can be used to perform both functions, thus allowing the circuit characteristics to be measured using a connection made at a single location.

Accordingly, the previous applications of Vasquez and Newton, and the Hensley patent, correctly theorized that a wiretap could be detected by measuring the attenuation of a reflected pulse due to junctions and other circuit impairments, such as the presence of wiretaps, although the devices disclosed thereby were not fully capable of implementing this realization. The present inventors have now additionally discovered that the attenuation due to the presence of a wiretap is often masked by the larger attenuation attributed to the complex underlying circuit of wires, electronics, and the like, that also typically exist on the circuit with the wiretap, necessitating further sophistication to differentiate therebetween. Further, as noted above, to be fully useful such a detection instrument must operate in situ with all other electronic devices operating and while the circuit is in operation. The instrument shown in the earlier application required further improvement in these respects.

Similarly, although Hensley was theoretically correct when he stated that a wiretap could be detected by his device, the Helmsley instrument is also not useful in all possible telephone circuit configurations. Helmsley furthermore does not describe in his application the effects of various line voltages, currents and typical signals on his device's ability to detect the wiretap.

Therefore, it is apparent that further improvements in instruments for detecting the presence of wiretaps and other circuit faults or irregularities is needed.

The first versions of the Vasquez/Newton apparatus (i.e., as disclosed in the US and PCT applications referred to above) were indeed designed to specifically detect wiretaps. Like Hensley, Vasquez and Newton theorized that when a waveform of suitable frequency was applied to a circuit where a wiretap was present, attenuation of the waveform would occur at the wiretap junction. When the attenuation is measured on a circuit with a wiretap versus the same circuit without a wiretap, the difference in attenuation could be used to qualitatively sense the presence of the wiretap.

Vasquez and Newton, in the earlier PCT and US applications mentioned above, and the present inventors herein, do not rely on comparison of measured values of conventional circuit parameters to stored values and do not employ the differences to identify deviations from wiretap-free telephone lines, as does Hensley. Instead, Vasquez and Newton, as well as the present inventors, both determine the VN, although the methodology employed by the present inventors is much more sophisticated than employed previously.

In the previous unit, the VN was the simple sum of 8 digital values provided by an analog-to-digital converter (ADC) measuring the signal strength. These readings were taken while each of 4 pulse-wave modulated carriers was active, for a total of 32 readings. The ADC used was capable of raw readings that can be as high as 1023. Before summing, however, each reading was reduced in precision by dividing the raw number by 32 such that its maximum value was 31. The loss of precision resulted in VN numbers that were both lower and far less sensitive than they could have been.

More specifically, in the previous unit, the VN could reach a maximum value of 31*32=992, a number that very conveniently fit into the 3-digit display used, but whose precision and therefore much of its value was lost. For example, if 32 raw readings were taken and each of the raw readings was 895, typical microprocessor integer math rules would produce the number 27 when 895 was divided by 32. That is, the division 895/32 results in a quotient of 27.969, but the decimal remainder is dropped in integer division, leaving only the whole number 27, which would then be contributed to the VN. In the example, this would have yielded a VN of 27*32=864. Had the remainder from each of the division steps not been truncated, the VN would have been 895. Thus, because of the premature division and integer mathematics, 0.969 of a VN was lost each time the reading was made, for a total of 31 VN points over 32 readings. This represented a significant loss in sensitivity.

In addition, four other factors that were not taken into account in the prior design have been addressed by the design of the current apparatus disclosed herein.

First, unavoidable variations in circuit components such as resistors, capacitors, etc. produce amplifiers and transmitters of varying characteristics, such that two ostensibly identical instruments typically will not produce the same results with respect to a given circuit under test. In order that all instruments produce the same VNs under identical conditions, as is critical to long-term monitoring, a methodology of normalizing the VN readings with respect to a standardized test circuit was needed, so that each instrument could be effectively calibrated.

Second, the earlier program design did not take into account the overall effects of duty cycle on the unit's sensitivity and therefore its ability to generate larger VN differences in response to configuration changes on circuits under test. That is, the earlier instrument transmitted pulse-width modulated energy into the circuit under test with constant duty cycle (i.e., the proportion of the time during which the signal value is high was held constant). It is now found that different duty cycles, varying with the frequency of the energy, are preferred as this gives more sensitive results. More specifically, the optimal duty cycle for each frequency should be uniquely determined for each unit during calibration, and employed during subsequent operations in order to achieve greatest VN variations in response to configuration changes in the circuit under test.

Third, the designers did not take advantage of the microprocessor's ability to quickly and accurately generate the range of frequencies that it was capable of generating. The current inventors established that by maintaining frequency and duty cycle specifications in tables that can be set during calibration time, the unit can quickly and efficiently transmit energy over a wide range of frequencies.

Fourth, the ultimate effects of higher frequency modulations on the apparatus' ability to detect small and/or previously undetectable configuration changes were unknown to the original designers. Empirical analysis demonstrated to the current inventors that high impedance junctions generate relatively large VN differences (up to 15 points) when stimulated by frequencies over 200 Khz and higher.

In conclusion, in order to maximize the apparatus' ability to sense configuration differences but still maintain the relative ease of use and stability of a 3-digit VN, the apparatus has to be calibrated. It has to collect and process raw numbers, factor the total reading against the high and low calibration values, then scale the number to fit into the 3-digit display. These goals are met by the present design disclosed herein.

After determination as above, the VN can then be recorded, and comparable measurements performed over time to identify changes indicative of new wiretaps and the like. In a further use, differences in the VN as measured with respect to ostensibly identical circuits can be used to identify the presence of wiretaps or other improper additions to one or the other. Thus, the apparatus can be used in a wider range of applications, such as both wiretap detection and telephone circuit analysis.

One of the operating modes of Hensley's device would cause it to sweep (modulate through all frequencies) between 200 hz and 10 Khz through the voice frequency range (i.e., 100 Hz through 20 Khz) in an attempt to trigger any voice-activated recording devices. ‘Sweeping’ through the voice frequency range can trigger certain automatic test functions of the telephone system, which render the circuit inoperative until the circuit is reset by the telephone company. This is highly undesirable and is avoided according to the present invention.

One aspect of the present invention relates to the discovery, made while analyzing various frequency configurations to detect wiretaps, that certain types of wiretaps were not detectable by waveforms that operate in the voice frequency range, even with frequencies as high as 20 Khz.

As above, while Hensley stated that a wiretap could be detected by his device, he failed to establish the validity of that particular claim with respect to all possible wiretaps and telephone circuit configurations. He furthermore does not describe in his application the effects of line configuration, voltages, ringer currents and other telephony factors to his device's ability to detect the wiretap.

Vasquez and Newton, on the other hand, theorized that the attenuation due to the presence of the wiretap was often being masked by the larger attenuation that was attributed to the underlying circuit of wires, electronics, etc. that also typically exist on the circuit with the wiretap.

In research performed after the filing of the US and PCT applications mentioned above, to overcome the masking problem, Vasquez discovered that when waveforms in a range of several frequencies (20 Khz and beyond) were applied to the circuit under test, the wiretap was much more easily and consistently detectable. The present application claims improved apparatus and methods implementing this discovery. Similarly, it has also been discovered that the shape of the the waveform transmitted into the circuit under test has a significant effect on the accuracy and replicability of the VN measured thereby, and this discovery is disclosed and claimed hereby as well.

However, Vasquez also found that the VN measured varies significantly with changes in line configuration, e.g., with additional equipment such as faxes, extensions, etc. present, even in the absence of wiretap equipment per se. He recognized that a practical application of this phenomenon is the ability of the apparatus to detect even small configuration differences between two circuits. One determination from further research into the phenomenon is that higher frequencies (50 Khz and higher) are more heavily attenuated by the types of junctions that are typical of higher-end wiretaps and monitoring devices.

Accordingly, an underlying principle of the invention is the realization that different circuit conditions and equipment will contribute in differing ways to the attenuation of signals of different frequencies transmitted into a circuit under test, and therefore that the precise VN measured will vary not only with respect to the various details of the circuit, but also with respect to the various signal components transmitted. In general, the apparatus is rendered more effective by adding additional frequencies to the mix of transmitted signals. However, it will be apparent that in order to provide repeatable measurements, the mix of signal components of various frequencies transmitted must remain constant from time to time. Accordingly, it is important to settle on a optimized signal that is effective, and use this same transmitted signal over time.

To demonstrate this principle, early prototype models of the apparatus as now disclosed, and thus not forming part of the prior art applicable to the present invention transmitted uncalibrated pulse-wave modulated carrier signals at four frequencies (20 Khz, 30 Khz, 40 Khz, 50 Khz) for durations of 400 milliseconds per frequency. These would display a statistically-significant and consistent 4-point difference in the VN. When measured against a maximum VN value of 992, this represents a 0.00403 or 0.403% change in the VN. The percentage change might be small, but is statistically significant. However, further improvements resulting in units transmitting signals with bursts at greater numbers of frequencies and frequencies up to 248 Khz generated up to 15-point differences in the VN for the same circuit configurations.

The 15-point change against the maximum VN of 999 represents a 0.01502 or 1.502% change in the VN, which represent a substantial improvement in the apparatus' ability to detect wiretaps.

The apparatus can be employed in situ, that is, on the telephone line with all other telephone devices operating. It operates in the presence of telephone system voltages (approximately 60 volts DC, but varying from 2 to more than 70 volts), telephone signals (e.g., dialtone) ringer current and telephone electronics (phones, faxes, switches, etc,) that are normally associated with the telephone system.

### OBJECTS OF THE INVENTION

There has never been any way for an individual or an organization to determine that two telephone circuits are indeed identical, except by costly and time-consuming physical inspection. The invention has as one object the satisfaction of this need.

More specifically, it is the object of the invention to provide equipment capable of identifying circuits or equipment that are different, or have become different and, in doing so, speed the identification and resolution of problematic circuits in today's complex telecommunications industry, specifically to detect wiretap equipment.

### SUMMARY OF THE INVENTION

The apparatus of the invention is a device that measures the attenuation effects of the physical construction of a telephone circuit, its electrical characteristics, and connected equipment with respect to a series of waveforms at different frequencies. The unit then combines the resultant values in a manner detailed below to determine a reference number called the Vasquez Number (VN), a unitless number that is representative of and can be considered the signature of the circuit under test.

In a preferred embodiment, the apparatus comprises a microprocessor, a transmitter, a transmitter amplifier, a receiver amplifier, and two analog-to-digital (A/D) converters. Conveniently, these components can be packaged together with an activation button, a display, 2 telephone-style jacks that are internally connected to each other, and a self-contained battery power source.

The apparatus can be attached to and perform a test on any analog telephone circuit or analog telephony device but will require some modification to be compatible with digital signaling methods. The apparatus can be the terminus of a line, or it can be interposed between a telephone circuit and a telephony device by using a pair of onboard internally connected telephone-style RJ45 connectors.

The apparatus is normally powered off, with no current drain from the battery. In normal operation, depressing the activation button causes a series of bursts of signals of various frequencies to be transmitted to the circuit and/or device under test. After reading the raw results of the test, the device processes the data and calculates the Vasquez Number (VN), as below; typically the VN will be displayed on a 3-digit 7-segment LED display provided as part of a self-contained unit.

The precise type of the series of bursts of signals of various frequencies to be transmitted to the circuit and/or device under test has been found to be important in obtaining the most repeatable results. In the early work reported in the US and PCT application mentioned above, a series of bursts of square-wave energy (i.e., a burst of pulse-width-modulated (PWM) energy at a 50% duty cycle) at up to 20 kHz were transmitted. As mentioned, this provides useful results, but more sophisticated signal sequences are now known to provide much more sensitive results. Specifically, transmitting square-wave signals at 20, 30, 40, and 50 khz provides a substantial improvement. Variation of the duty cycle of PWM energy from the 50% value of a “square” wave provides increased sensitivity; the duty cycle most preferred will vary with the frequency. Similarly, operation at substantial higher frequencies, up to 250 khz, and possibly higher, provides further improvement. It may be preferable to adjust the duty cycle of the PWM energy as a function of frequency, so that the same amount of energy is transmitted at each frequency, but this has not been finally determined. (As of the filing of this application not all relevant testing has been completed.) Sine wave energy at a variety of frequencies is also useful.

In a particularly preferred embodiment, circuitry for transmitting PWM energy as well as sine waves may be provided in the same unit, with a switch provided to allow the operator select therebetween. PWM energy may be preferred for analysis of local circuit issues, while the sine-wave energy is apparently more appropriate for analysis of the larger network.

Whether sine-wave or PWM energy is transmitted, it is essential that all units determine the same VN with respect to a particular circuit. Therefore, all units are to be calibrated at manufacture against a reference circuit so that all give identical results. In the case of the PWM circuitry in particular, this is expected to involve variation of the duty cycle of the various frequency components. Hence it is not possible to say with certitude which is the “best” combination of duty cycles and frequencies.

One of the reasons that the current apparatus is far more responsive than the previous implementation is because the combination of its transmitter and amplifier/ADC circuitry at any given frequency has been optimized by calibration. The transmitter's output is adjusted by setting the parameter known as duty cycle during calibration to produce the highest level of returned energy to the amplifier/ADC. The analogy to this principle is that if one has 1000 units of energy to work with and the smallest unit of measurement is 1 unit, then one can achieve a precision of 0.001 or 0.1% of that circuit. If however, the amplifier is only outputting 100 units of energy, then at best the receiver will only see 100 units, and with that same amplifier, will achieve a precision of 0.01 or 1%, ten times less sensitive than the transmitter that is tuned to transmit its full energy.

During calibration for each frequency, the duty cycle is incrementally set and the received energy is measured until the ADC reaches its maximum value without overflowing. When the optimal duty cycle is thus found, its value is stored in the memory of the device.

Then, during normal readings the apparatus' program will recall the duty cycle that was associated with its respective frequency when making each reading.

Derivation of the VN is straightforward. When the apparatus captures a reading during a test, it stores the raw value of that reading in the nth occurrence of an array element, much like storing a series of numbers in different columns of the same row in a spreadsheet.

Given that the array is called RAD, the first reading is stored in RAD[1], the second in RAD[2], . . . until the last reading which is stored in RAD[32]. The VN calculation uses the high value and low value that were determined during calibration.

The high value is the sum total of all the raw readings that were taken when the apparatus did not have anything plugged into it. The low value is the sum total of all the raw readings that were taken when the telephony input ports were short circuited. The VN then is calculated by:

VN=((sum(RAD[1] . . . [32])−calibration_lowvalue)*999)/(calibration_highval-calibration_lowval)

where 999 is the scaling factor to fit the number into the 3-digit display.

Assuming that we take a reading with nothing plugged into the apparatus, sum(RAD[1] . . . [32]) will equal the original calibration high value, which when subtracted by the calibration low_value will equal (calibration_highval-calibration_lowval) on the bottom of the equation, producing unity. Computer integer mathematics require the mathematical calculation sequence above to properly apply the scaling factor.

That the unitless VN is calculated and displayed is critical, but even more critical is how the information is analyzed and used. Typically, the apparatus will be employed by a technician or analyst at a location that is reporting that the telephone line is operating poorly, or that a wiretap is suspected.

The analyst first takes a series of several readings to establish a “baseline” value of the target circuit in various configurations. Then, typically, the analyst takes a series of readings under the same conditions for lines that are supposedly configured the same (“control” circuits). In the case of a home telephone, a second line or neighbors' lines could be checked after securing permission from the neighbor to do so.

If the circuit under test is the subscriber loop from the network interface device (NID) to the central office facility, the telephone company would be typically called in to identify why the circuit under test is different from the control circuits. In-house circuit technicians would typically be employed to identify the cause(s) of in-house circuit differences.

If there are statistically significant differences in the VNs that are displayed (i.e., several readings that are consistently two or more points lower,) it usually means that the circuit under test is configured differently than the control circuit. The apparatus has no means of identifying what is different, it simply tells the analyst that something is different.

The apparatus has been employed on numerous occasions in just such a manner, with the VN properly identifying configuration differences with no false positives.

Stated somewhat differently, different frequencies of various waveforms are attenuated in different ways by the junctions, impedance, capacitance and other electrical and electronic devices in the circuit, and thus the attenuation of each frequency and waveform, when analyzed, will result in a unique value. If each value were individually plotted on a graph, the individual values would become a “fingerprint” of the circuit. If two circuits were indeed identical, each circuit would attenuate each frequency and waveform by the same amount, and have the same fingerprint. Because the VN is derived from the individual measurements, the VNs for the two circuits would be identical (with possibly some statistically insignificant variance in readings.) In effect, the VN can be used to confirm that two circuits that are represented as being identical are indeed identical.

The apparatus can measure and calculate a VN under various telephone line conditions. It can take measurements when conversation is taking place or when the telephone equipment is on-hook or off-hook, when the line is dry (no voltage present) or wet (telephone company (telco) line voltage present), when telephone ringer current is active (telephone is ringing) or when a dial tone is present.

The value of the VN signatures is that once they have been acquired, a trained technician can rapidly establish qualitative differences in the configuration of the individual circuits in a wiring plant. The wiring plant can be within the walls of an office space, or it can be an entire service area for a large telephone switch. With a high degree of confidence, the technician can ascertain that circuits that are claimed to be identical, or that were to have been provisioned identically are, in fact, identical, and still further, the technician has the ability to rapidly identify non-conforming circuits.

A VN can be generated for:

1. Unterminated or terminated wire conductor pairs.

2. Dry (not dialtone-capable) or wet (dialtone-capable) conductor pairs that are typically used in telephone company central office (CO)-to-subscriber-premises, and which may consist of several loops of wires with “MFTs” (Special amplifiers to boost dial-tone signal amplitude to cover telco attenuation losses over longer distances)

3. In-house wiring from the telephone company's network interface device (NID) to stations or any subsegment thereof

4. Conditions 1 through 3, above, with or without the presence of electrical devices that are normally associated with telephone operations, such as telephones, telephone switches, fax machines, PBXs, Central Office switches, answering machines, etc.

5. Condition 4, above, regardless if telephone gear is powered up.

6. A subcomponent of a piece of telephone gear (e.g., a telephone handset, with or without the cord) that has been disconnected from the main body of the instrument.

7. Conditions 1 through 5, above, regardless of the presence or absence of low-voltage DC normally associated with the telephony.

8. Conditions 1 through 5, above, regardless of the presence or absence of a telco dial-tone,

9. Conditions 1 through 5, above, regardless of the presence of absence of telephone company (telco) ringer current (AC up to 90V and sometimes higher).

### BRIEF DESCRIPTION OF THE DRAWINGS

The invention will be better understood if reference is made to the accompanying drawings, in which:

FIG. 1 is a schematic sketch illustrating how the apparatus of the invention can be connected between a telephone and the telephone circuit, in one manner of its use;

FIG. 2 is a block diagram showing the overall design of the circuitry of the apparatus of the invention, in a first pulse-width-modulating (PWM) embodiment; and

FIG. 3 is a comparable block diagram showing the overall design of the circuitry of the impedance-matched sine wave version of the apparatus.

### DESCRIPTION OF THE PREFERRED EMBODIMENTS

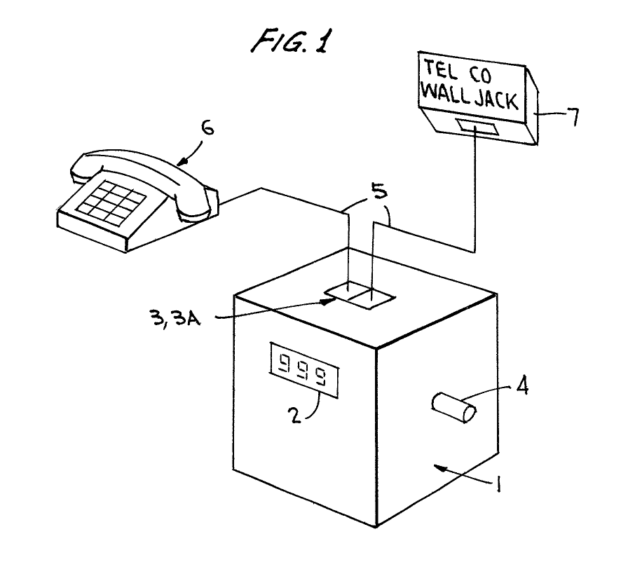

A simplified view of a currently-preferred embodiment of the invention is shown in FIG. 1. The apparatus is a hand-held unit [1] whose only user control is the power-activation button [4]. Using standard telephone patch wires [5], the operator of the apparatus connects the circuit under test [7] to either of two telephony interface ports [3], [3A]. If interposing the instrument of the invention between a telephone circuit [7] and a telephony instrument (telephone, fax, modem, etc.) [6], as illustrated, the operator connects the circuit [7] to one of the two telephony ports [3] and the device [6] to the other port [3A]. When the operator presses button [4], the device automatically carries out a series of tests discussed in detail below, calaculates the VN from the results of the tests, and displays the measured VN on display [2]. Typically the operator will record the VN manually, for future comparison, but it is within the scope of the invention to provide a memory device in the unit for doing so.

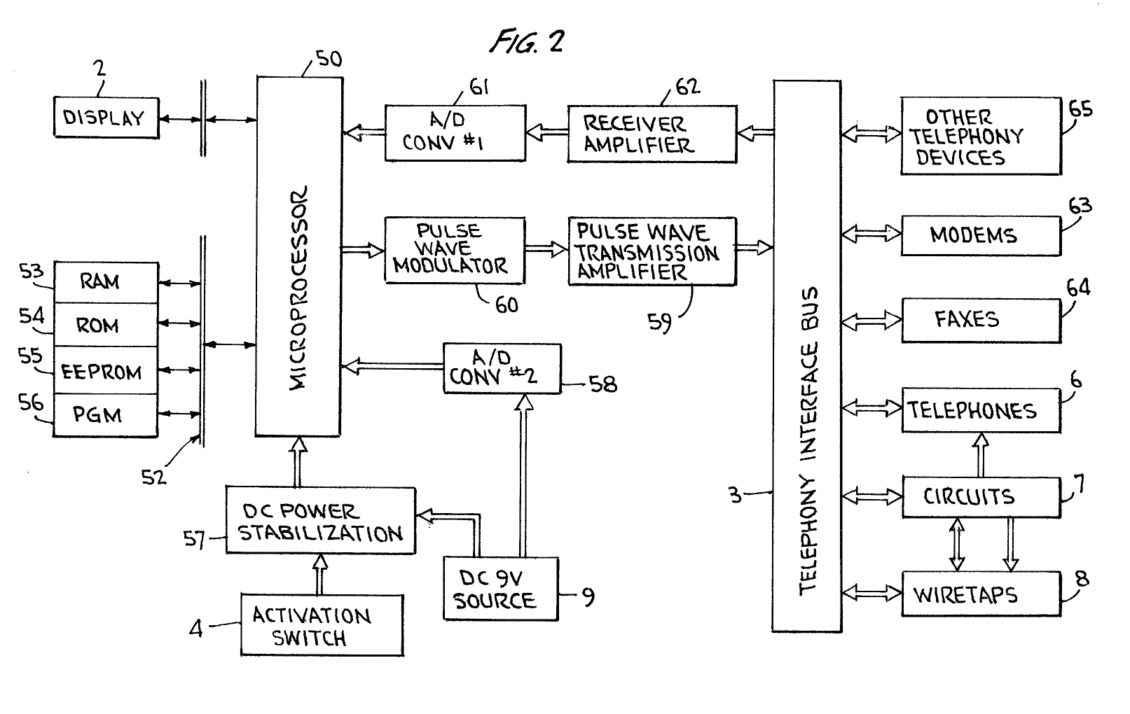

Referring now to the circuit block diagram of FIG. 2, showing the circuit of an instrument for transmitting pulse-width modulated (PWM) energy (hereinafter sometimes “pulses”), depressing the power activation button [4] activates a power conditioning circuit [57] that delays actual startup of the microprocessor [50] until the power available to the microprocessor has reached a certain threshold and is stable.

The microprocessor [50] first performs some basic self-checks, including using one of the two A/D converters [58, 61] to sample the battery's [9] voltage to determine if enough voltage exists to run a test and get accurate readings. If insufficient voltage is detected, the operator is flashed a low-battery warning on the LED display [2] and tests are not performed. Below a critical threshold, far below the low-battery warning threshold, the unit will not even power-up to be able to flash a warning.

A preferred microprocessor is the model No. 16F876 from Microchip, which includes an onboard pulse wave modulator [60]. The microprocessor [50] controls the onboard pulse wave modulator [60] to generate a series of modulated pulse waves (an on-off series of pulses of energy at a given frequency, where the relative length of the on and off periods is the “duty cycle”; a “square wave” results when they are equal, at a 50% duty cycle) at predetermined frequencies and duty cycles. These are then used to control the transmit amplifier [59] to transmit the pulse wave modulated carrier for 50 ms bursts at 32 different frequencies into the telephony interface [3] and thence to the devices that are attached thereto. Each burst of PWM energy, at each frequency, is transmitted for a specific period of time established empirically as the optimal stabilization time for both the transmit pulse waves as well as receive amplifier [62] stabilization.

As above, each pulse wave is defined by two components, both of which are stored in the electrically-erasable-programmable-read-only-memory (EEPROM) [55] of the unit. The first of these numbers is the factor that will generate the pulse waves at a specific frequency. Frequency of pulse waves is defined as the number of times in a time interval that the pulse wave goes from a ‘0’ (fully off) state to a ‘1’ (fully on) state. The second factor is duty cycle, or the length of time that the pulse wave will remain at the ‘1’ (fully on) state. At a duty cycle of 50%, the pulse wave and a true square wave are indistinguishable.

The frequency and duty cycle tables are stored in EEPROM[55] during calibration. Other memory usage includes reference data that is stored in ROM [53] along with the program's code in PGM memory [56]. RAM [54] or random-access memory is used during the program's test run to store working data during analysis and for final LED readout.

During transmission of the pulses, as above, the receiver amplifier [62] is continually sensing the intensity of the attenuated resultant signal from the telephony interface [3] and presents this information to the second A/D converter [61]. The total energy output of the amplifier is calibrated to remain below the overflow threshold of the ADC, so that the receive amplifier can remain on during transmission. At the end of each frequency period, the second A/D converter [61] is activated and permitted to stabilize before sampling and converting the amplifier's output to a 10-bit digital representation. When readings for all frequencies have been performed, the microprocessor then converts and normalizes all the readings into the single 3-digit VN for display to the operator via the LED display [2]. As above, calculation of the VN is straightforward. The unit sums all the raw readings that are taken during a test and factors them with calibrated values for maximum high and minimum low values, then scales the number to fit into the 3-digit display.

The precise calculation is:

VN=((sum(RAD[1] . . . [32])−calibration_lowvalue)*999)/(calibration_highval-calibration_lowval)

Where 999 is the scaling factor to fit the number into the 3-digit display, RAD[1], RAD[2] . . . RAD[32] are the individual raw readings, calibration_highval is the maximum number that was established during calibration to determine the maximum raw value that could be attained and calibration_lowval is the minimum number that was also determined during calibration by short-circuiting the telephony input ports and taking another set of readings.

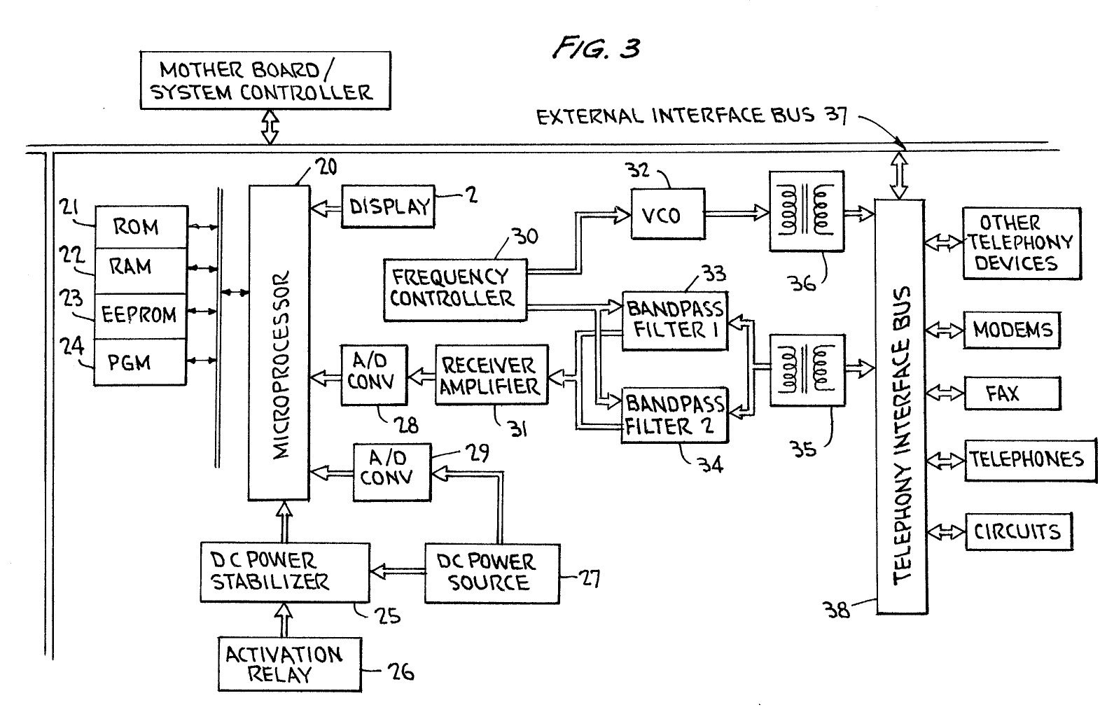

FIG. 3 shows a similar block diagram of the circuitry for transmitting a series of sine waves at fixed amplitude and fixed duration, but at varying and higher frequencies than the current apparatus. These will be transmitted into the telephony interface at a relatively low but constant fixed energy level (−20 db to −30 db.) A set of precision bandpass filters are employed to isolate the stimulating frequencies and thus determine the attenuation effects of that and only that frequency on the circuit under test.

Tests have already demonstrated the efficacy of this approach, especially in sensing very-high impedance junctions that are characteristic of wiretaps. Tests indicate the technique could produce VN variations as high as 100 points in response to certain wiretaps, and the technique allows for long-term attachment to the telephone network. FCC certification is being sought.

It is anticipated that the duration of each frequency burst will be approximately 50 milliseconds, which gives the receiver amplifier enough time to acquire a stable return signal and in turn present a stable return to the microprocessor's ADC port.

The apparatus will be activated by a control lead from an external interface bus [37]. In this embodiment, the unit does not have manual control capability and is designed to run as a daughter board in a system that provides the display and manual control capability, but it could readily be converted to a_stand-alone, independent unit. The telephony interface [38] will also not be directly accessed by the operator, but will access telephony devices using the external interface bus [37].

Closing the activation relay[26] sends a signal to the power stabilization circuit [25] that delays actual startup of the microprocessor [20] until the power available to the microprocessor has reached a certain threshold and is stable, generally as discussed above.

The microprocessor [20] first performs some basic self-checks, including using one of the two A/D converters [29] to sample the DC voltage source [27] to determine if enough voltage exists to run a test and get accurate readings. If insufficient voltage is detected, a message is sent across the external interface bus [37] to the controlling system indicating the condition. The processor will then enter s low-power sleep state without performing any tests.

The microprocessor [20] communicates with an intelligent frequency controller [30], and instructs it to generate a specific frequency for a specific time period. The frequency controller activates one of two controllable active/standby bandpass filters [33] or [34], whichever is not active, and instructs it to switch its high-pass and low-pass filter sections to the frequency range corresponding to the frequency that will be transmitted. Since it takes up to 100 ms to stabilize a programmable bandpass filter, the use of the active/standby filters [33],[34] is essential. The frequency controller [30] then instructs a voltage-controlled oscillator (VCO)[32] to send sine waves at the desired frequency and amplitude to the transmit impedance-matching transformer [36] which energizes devices and circuits on the telephony interface bus [38].

As soon as the VCO [32] begins to generate signal to the telephony bus via the transmit impedance matching transformer [36], the receive impedance-matching transformer begins to receive signal from the telephony bus [38]. Output from the receive impedance-matching transformer [35] energizes the input section of the dual-input amplifier [31] such that the amplifier generates and presents to the ADC a stabilized DC representation of the AC voltage reading.

When the burst of sine wave energy of proper length has been transmitted, the microprocessor sends a message to the ADC [28] to perform a reading. The ADC [28] generates a 10-bit digital number representing the strength of the input sensed by the receive amplifier [31], which is a representation of the original transmit signal less attenuation.

Attenuation measurements are performed at a variety of frequencies, as in the pulse wave apparatus. When the series of measurements at the various frequencies has been exhausted, the microprocessor [20] calculates the VN as above, and again communicates with the motherboard via the external interface bus [37] to send its set of readings.

Following that last step, the processor enters a low-power sleep mode until all DC power [27] is removed from the board.

There are no special manufacturing considerations for board assembly in either embodiment, but those of skill in the art will recognize that there are thermal sensitivities in the pulse wave apparatus. Assuming linearity of the thermal curve, or correction factors determined during calibration, thermal compensation can be applied when calculating the VN.

Since each transmit and receive amplifier in the pulse wave apparatus will have slight variations in the quality of components used, the same test conditions may result in different VNs for different units. Each unit must be subjected to an extensive set of calibration routines which set optimal values for transmission parameters and for calculating the final VN in order that the VNs determined by each unit are directly comparable.

In an ultimately preferred embodiment, the apparatus as described above may become part of an overall system. In this embodiment, the hand-held unit of FIG. 1 might be docked into a main system housing another type of VN generator using impedance-matching transformers and pure sine generators to produce an even wider range of stimulus frequencies.

The docked system approach provides for either the pulse wave or sine wave unit be undocked and replaced if necessary, or for the sine wave unit to be left permanently attached to the target telephone line for continuous monitoring.

The sine wave apparatus uses a sine-wave oscillator to generate much higher frequencies than is possible with pulse wave technology, since sine waves will propagate through impedance-matching transformers, whereas pulse waves will collapse and become ineffective. Frequencies of up to 250 KHz, and possibly higher, appear to be very useful in the practice of the invention.

The sine wave unit is an evolution and enhancement of the pulse wave apparatus. The additional components and precision circuitry that will be required will also make the unit more costly. Some of the characteristics of the sine wave apparatus will make it ideal for testing modes that are not suitable for the pulse wave apparatus.

First, the sine wave unit only measures the attenuation of its own sine waves, and not the background noise of the telephone system or other factors. This is accomplished through the employment of high-quality bandpass filters that will send only the attenuated waveforms of the originally transmitted sine waves into the amplifier. The decibel (db) range of the affected waves typically falls into a narrow band while the attenuation caused by junctions like those of wiretaps will typically be very significant statistically (10% or more). In generating the VN, this represents a VN difference of 100 on a 999 scale whereas the pulse wave apparatus typically exhibits only 15 points difference with respect to the same circuits.

The sine wave unit is also more stable than the pulse wave unit. The pulse wave unit must measure the entire telephone line and its noise and other dynamics such as dialtone, conversation, and ringer current. The presence of these aberrations produces a different VN than the reading of a simple wet line with no other activity, so the technician has to be trained to recognize the condition that the line was in when the reading was taken.

On the other hand, the sine wave unit measures its own returned signal and because of the bandpass filter, ignores all other noise. The measured readings of the returned signal are very stable, with long-term monitoring stability a bonus.

Accordingly, those of skill in the art will recognize that there are a number of options with respect to the preferred embodiment of the invention from which selection may be made depending on the precise circuit to be monitored. Similarly, there are further improvements and modifications to the device and its method of use which will be apparent to those of skill in the art. Therefore, the invention should not be limited by the above exemplary disclosure, but only by the following claims.

What is claimed is:

1. Apparatus for characterizing telephone lines and circuitry connected thereto, comprising:
a signal generator, for generating a series of calibrated signals at frequencies varying over a range;
a transmit amplifier, for transmitting said generated signals into said telephone lines,
a receive amplifier, connected to said telephone lines, for detecting attenuation of said transmitted signals;
means for analyzing the attenuation of the received signals and for analyzing the same to generate a dimensionless Vasquez Number responsive thereto.

2. The apparatus of claim 1, wherein said series of signals comprise a series of sine waves at various frequencies between about 20 KHZ and 250 kHz.

3. The apparatus of claim 1, wherein said series of signals comprise a series of pulse-width-modulated signals at various frequencies.

4. The apparatus of claim 3, wherein the duty cycle of said series of pulse-width-modulated signals at various frequencies varies as a function of frequency.

5. The apparatus of claim 4, wherein the duty cycle of the various pulse-width-modulated signals is determined and set during a calibration step, such that the Vasquez Number determined by each said apparatus is substantially identical with respect to various circuits.
